(19) United States
(12) Patent Application Publication
(10) Pub. No.: US 2016/0280462 A1
(43) Pub. Date: Sep. 29, 2016

(54) UTILITY HOOK DEVICE

(71) Applicant: David R. Arno, Magna, UT (US)

(72) Inventor: David R. Arno, Magna, UT (US)

(21) Appl. No.: 14/669,188

(22) Filed: Mar. 26, 2015

(51) Int. Cl. B65G 7/12; A45F 5/02; B25J 1/04

(52) U.S. Cl. CPC B65G 7/12; B25J 1/04; A45F 5/02

(57) ABSTRACT

A utility hook device facilitates engaging and picking up items and stores compactly while not in use. The device includes a tube having a first end and a second end, the second end of the tube is open. An arm extends into the second end of the tube and is extendable from the tube into an extended position. A stop is coupled to the tube proximate the second end to engage the arm in the fully extended position preventing the arm from being uncoupled from the tube. A handle is coupled to the first end of the tube. A hook is coupled to a distal end of the arm relative to the second end of the tube.

### BACKGROUND OF THE DISCLOSURE

### Field of the Disclosure

The disclosure relates to hook devices and more particularly pertains to a new hook device for providing a facilitating engaging and picking up items and storing the device compactly while not in use.

### SUMMARY OF THE DISCLOSURE

An embodiment of the disclosure meets the needs presented above by generally comprising a tube having a first end and a second end, the second end of the tube is open. An arm extends into the second end of the tube and is extendable from the tube into an extended position. A stop is coupled to the tube proximate the second end to engage the arm in the fully extended position preventing the arm from being uncoupled from the tube. A handle is coupled to the first end of the tube. A hook is coupled to a distal end of the arm relative to the second end of the tube.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a bottom front side perspective view of an embodiment of the disclosure in a compacted position.

FIG. 2 is a partially exploded top front side perspective view of a utility hook device according to an embodiment of the disclosure.

FIG. 3 is a top front side perspective view of an embodiment of the disclosure in a stored position.

FIG. 4 is a top front side perspective view of an embodiment of the disclosure in an extended position.

FIG. 5 is a cross-sectional view of an embodiment of the disclosure taken along line 5-5 of FIG. 4.

FIG. 6 is an exploded bottom front side perspective view of an embodiment of the disclosure.

### DESCRIPTION OF THE PREFERRED EMBODIMENT

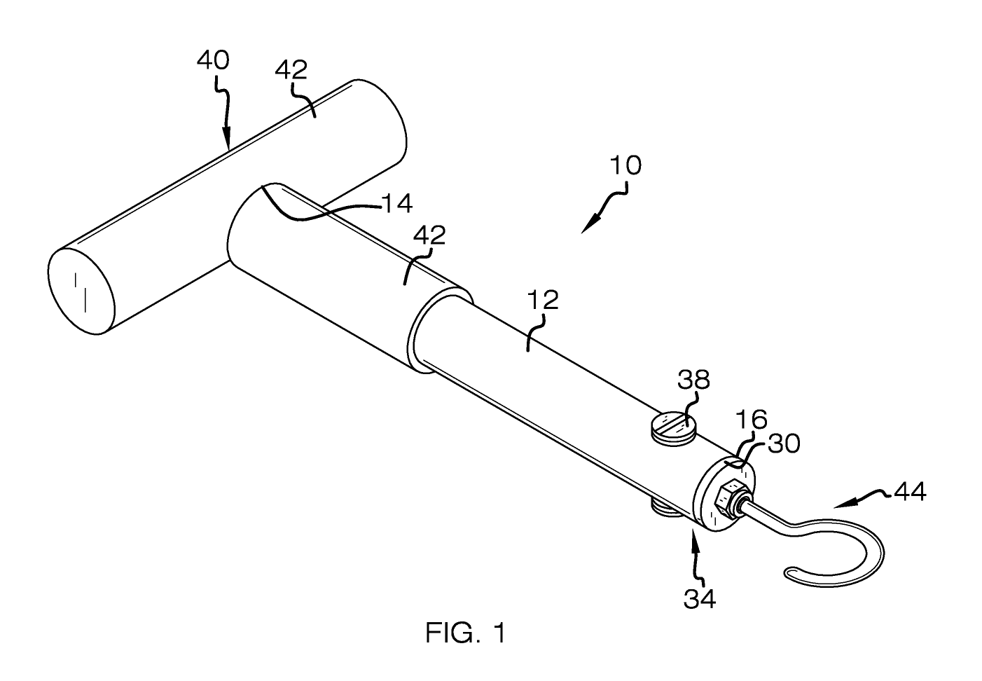

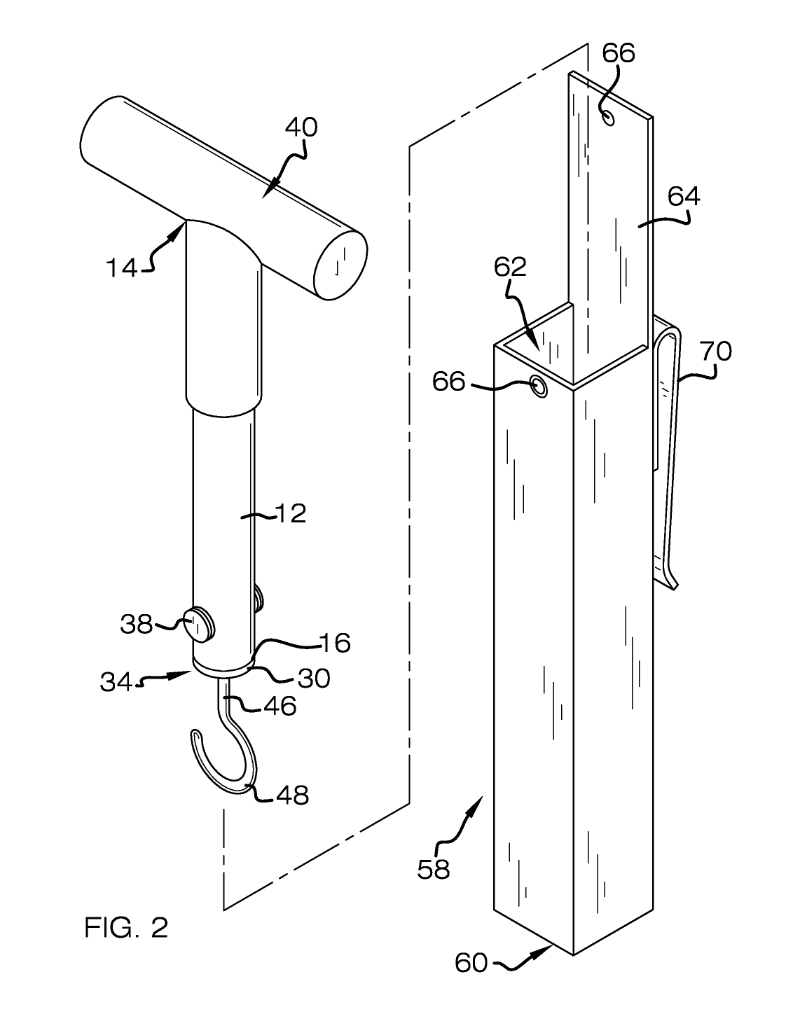

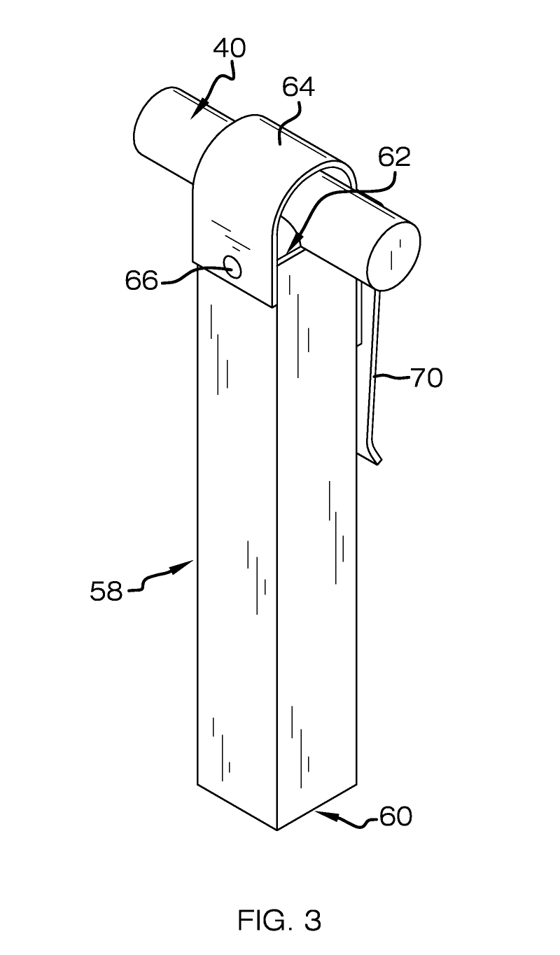

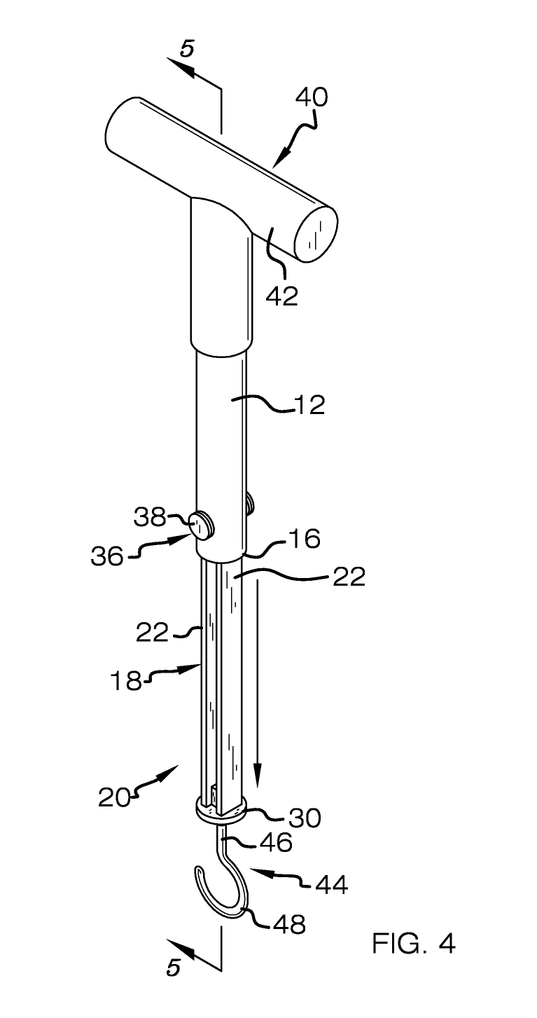

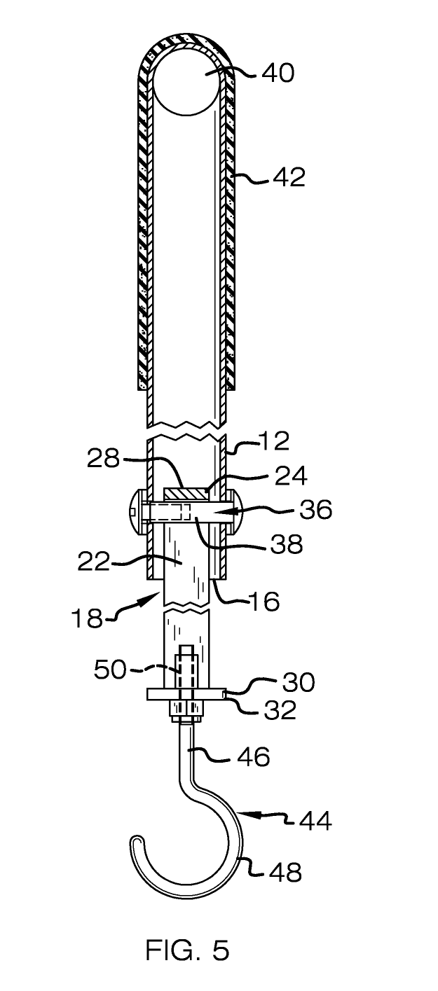

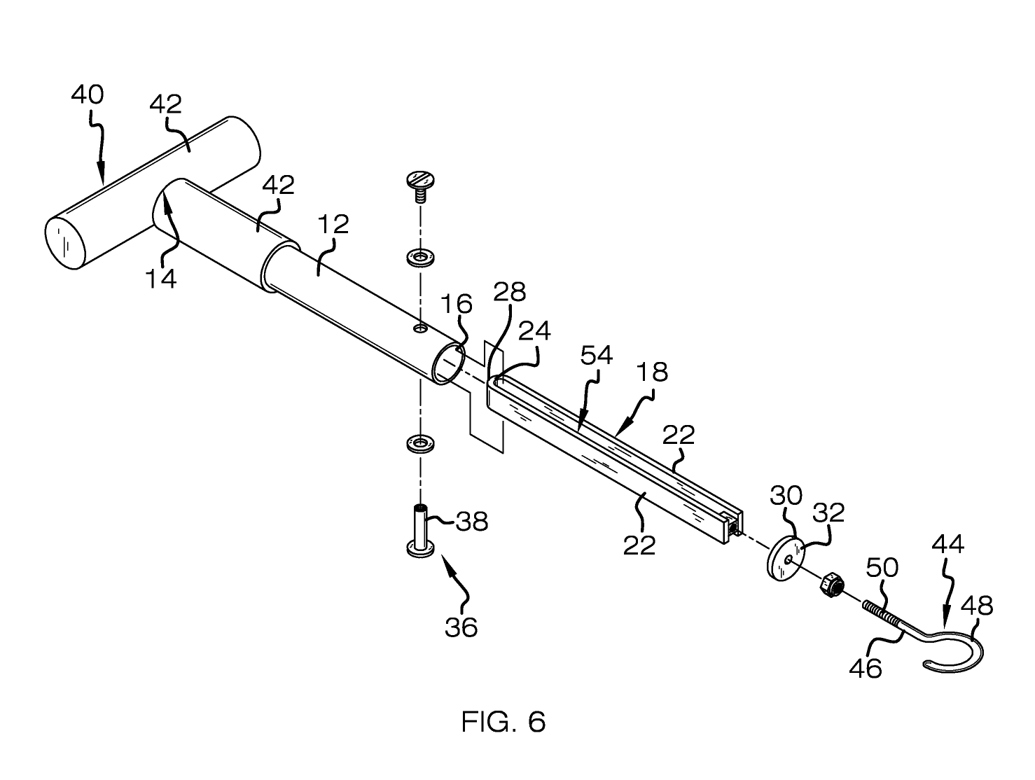

With reference now to the drawings, and in particular to FIGS. 1 through 6 thereof, a new hook device embodying the principles and concepts of an embodiment of the disclosure and generally designated by the reference numeral 10 will be described.

As best illustrated in FIGS. 1 through 6, the utility hook device 10 generally comprises a tube 12 having a first end 14 and a second end 16. The second end 16 of the tube 12 is open. An arm 18 extends into the second end 16 of the tube 12. The arm 18 is extendable from the tube 12 into an extended position 20. The arm 18 comprises a pair of elongated planar side sections 22 and a curved junction 24 integrally coupling the side sections 22 together. The curved junction 24 defines a proximal end 28 of the arm 18 relative to the tube 12. The arm 18 has a lip 30. The lip 30 extends outwardly at a distal end 32 of the arm 18 relative to the tube 12. The lip 30 abuts the tube 12 when the arm 18 is in a fully compacted position 34 within the tube 12.

A stop 36 is coupled to the tube 12 proximate the second end 16. The stop 36 engages the arm 18 when the arm 18 is fully extended from the second end 16 of the tube 12 such that the stop 36 prevents the arm 18 from being uncoupled from the tube 12. The stop 36 is a pin 38 coupled to and extending through the tube 12. The pin 38 may be threaded and secured to the tube 12 by a locking nut, washer or the like.

A handle 40 is coupled to the first end 14 of the tube 12. The handle 40 is cylindrical and oriented perpendicular to the tube 12. The handle 40 has an outer layer 42 constructed of rubber or the like. The outer layer 42 may be extended down the tube 12 from the first end 14 towards the second end 16.

A hook 44 is coupled to the distal end 32 of the arm 18 relative to the second end 16 of the tube 12. The hook 44 has a straight shank 46 and a bend 48 extending from the shank 46. The bend 48 forms a partial circle extending between 240 and 280 radians around a center of the partial circle. The shank 46 is engaged to the distal end 32 of the arm 18 relative to the second end 16 of the tube 12. The shank 46 has a threaded section 50 inserted into an aperture 52 in the distal end 32 of the arm 18. A slot 54 extends longitudinally along the arm 18. The stop 36 extends into and through the slot 54. The threaded section 50 extends through the aperture 52 and into the slot 54. A locking nut 56 engages the threaded section 50 of the shank 46 wherein the hook 44 is secured to the arm 18.

A holster 58 is provided. The holster 58 has a closed bottom 60 and an open top 62. The handle 40 extends out of the open top 62 when the hook 44, the arm 18, and the tube 12 are fully inserted into the holster 58. A strap 64 is coupled to the holster 58. The strap 64 is extendable over the handle 40 and engageable to the holster 58 using a coupler 66 such as a snap or the like. Thus, the strap 64 retains the hook 44, the arm 18, and the tube 12 in the holster 58. A clip 70 is coupled to the holster 58 wherein the holster 58 is configured for being coupled to a garment such as a belt, a waistband, or the like.

In use, the handle 40 is grasped and the arm 18 extends from the tube 12 when removed from the holster 58. The hook 44 is used to extend the reach of a person and ease the gripping strength necessary to hold and pull items such as chain, lines, or the like. The hook 44 may also be inserted through an aperture or engaged to a rod to facilitate twisting of a structure.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A utility hook device comprising:
a tube having a first end and a second end, said second end of said tube being open;
an arm extending into said second end of said tube, said arm being extendable from said tube into an extended position;
a stop coupled to said tube proximate said second end, said stop engaging said arm when said arm is fully extended from said second end of said tube such that said stop prevents said arm from being uncoupled from said tube;
a handle coupled to said first end of said tube;
a hook coupled to a distal end of said arm relative to said second end of said tube said hook having a shank and a bend extending from said shank, said shank being engaged to said distal end of said arm relative to said second end of said tube, said shank having a threaded section inserted into an aperture in said distal end of said arm;
a slot extending longitudinally along said arm, said stop extending into said slot, said threaded section extending through said aperture and into said slot; and
a locking nut engaging said threaded section of said shank wherein said hook is secured to said arm.

2. (canceled)

3. The device of claim 1, further comprising said arm comprising a pair of elongated planar side sections and a curved junction integrally coupling said side sections together, said curved junction defining a proximal end of said arm relative to said tube.

4. (canceled)

5. (canceled)

6. (canceled)

7. The device of claim 1, further comprising said handle being cylindrical.

8. The device of claim 1, further comprising said stop being a pin coupled to and extending through said tube.

9. The device of claim 1, further comprising a holster, said holster having a closed bottom and an open top, said handle extending out of said open top end when said hook, said arm, and said tube are fully inserted into said holster.

10. The device of claim 9, further comprising a strap coupled to said holster, said strap being extendable over said handle and engageable to said holster wherein said strap retains said hook, said arm, and said tube in said holster.

11. The device of claim 10, further comprising a clip coupled to said holster wherein said holster is configured for being coupled to a garment.

12. The device of claim 1, further comprising said handle having an outer layer being constructed of rubber.

13. The device of claim 1, further comprising said arm having a lip, said lip extending outwardly at said distal end of said arm relative to said tube, said lip abutting said tube when said arm is in a fully compacted position within said tube.

14. A utility hook device comprising:
a tube having a first end and a second end, said second end of said tube being open;
an arm extending into said second end of said tube, said arm being extendable from said tube into an extended position, said arm comprising a pair of elongated planar side sections and a curved junction integrally coupling said side sections together, said curved junction defining a proximal end of said arm relative to said tube, said arm having a lip, said lip extending outwardly at a distal end of said arm relative to said tube, said lip abutting said tube when said arm is in a fully compacted position within said tube;
a stop coupled to said tube proximate said second end, said stop engaging said arm when said arm is fully extended from said second end of said tube such that said stop prevents said arm from being uncoupled from said tube, said stop being a pin coupled to and extending through said tube;
a handle coupled to said first end of said tube, said handle being cylindrical, said handle having an outer layer being constructed of rubber;
a hook coupled to said distal end of said arm relative to said second end of said tube, said hook having a shank and a bend extending from said shank, said shank being engaged to said distal end of said arm relative to said second end of said tube, said shank having a threaded section inserted into an aperture in said distal end of said arm;
a slot extending longitudinally along said arm, said stop extending into said slot, said threaded section extending through said aperture and into said slot;
a locking nut engaging said threaded section of said shank wherein said hook is secured to said arm;
a holster, said holster having a closed bottom and an open top, said handle extending out of said open top end when said hook, said arm, and said tube are fully inserted into said holster;
a strap coupled to said holster, said strap being extendable over said handle and engageable to said holster wherein said strap retains said hook, said arm, and said tube in said holster;
a clip coupled to said holster wherein said holster is configured for being coupled to a garment.
